(19) United States
(12) Patent Application Publication
(10) Pub. No.: US 2009/0208656 A1
(43) Pub. Date: Aug. 20, 2009

(54) Scented container or dispenser and method of scenting product by scenting its container or dispenser

(76) Inventors: Andreas Brown, Prior Lake, MN (US); Anil Segat, Minneapolis, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/321,803

(22) Filed: Jan. 26, 2009

Related U.S. Application Data
(60) Provisional application No. 61/062,376, filed on Jan. 25, 2008.

(51) Int. Cl. B05D 3/00; B05D 1/28

(52) U.S. Cl. 427/331; 427/428.01

(57) ABSTRACT

Articles, such as protective elastomeric gloves, are scented by scenting the interior surface of a container, particularly containers made of a two-dimensional form that is folded into a container shape. Scent can be applied to the inside of the container before it is folded through various methods, including rolling scent onto it, spraying scent onto it, adhering a strip of scented material to it or fogging it. Articles within the container acquire scent from the container during storage and transport.

This application claims priority to USSN 61/062,376, filed Jan. 25, 2008.

### FIELD OF THE INVENTION

This invention relates to the field of indirect scenting of articles and more particularly to scenting an article by scenting the inside surface of its container.

### BACKGROUND

The scenting of articles, particularly protective elastomeric gloves, is sometimes desirable. Typically such scents are applying by spraying, tumbling or otherwise applying a liquid to gloves during their manufacturer. Applying chemicals to scent such articles adds additional steps, time and complications to the manufacture of the article itself.

### SUMMARY OF THE INVENTION

Scent is applied to an inner surface of a container and/or product dispenser during or after its manufacture but prior to being filled with product. Unscented articles stored in the container or dispenser absorb the scent during their time spent in the container or dispenser, such that they are scented by the time they are dispensed or used.

Scent transfer is enhanced by jostling of the containers that occurs during shipping.

This scenting of containers is of particular use for scenting elastomeric gloves of natural or synthetic materials, such as those used in the medical and dental fields.

This invention provides a package scented on its internal surface, a method of scenting the package and a method of scented articles stored in a package that is scented on its internal surface.

### BRIEF DESCRIPTION OF FIGURES

FIG. 1 depicts cardstock pattern for forming a package or container;

FIG. 2 depicts a package formed by folding the cardstock of FIG. 1;

FIGS. 3a-d schematically depict methods for applying scent to the cardstock of FIG. 1.

### DETAILED DESCRIPTION OF PREFERRED EMBODIMENT(S)

In lieu of scenting articles themselves during their manufacture, packaging, containers or dispersers (hereafter “packaging”) for the articles is scented. Then during storage of the articles in the packaging, the articles absorb the scent from the packaging such that by the time the articles are dispensed, the articles are scented. More specifically, the scent transfers from the packaging surface to the articles in one or both of these ways: 1) the articles contact the scented portion of the inner surface of the container; and/or 2) the scent molecules evaporate into the air within the package and then are deposited on the surface of the articles. Jostling of the closed packages of articles during transport aids in facilitating this transfer of scent from the package to the articles.

Scenting packaging is particularly well suited for conveying scent to protective gloves, such as natural and synthetic elastomeric gloves. Such gloves are typically packaged in cardboard boxes, with dozens or hundreds of gloves in a box, that also serve as dispensers for the gloves.

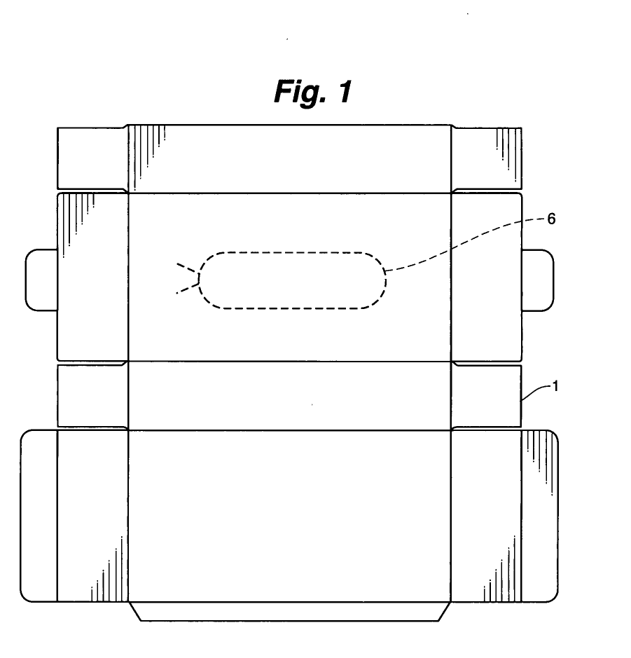

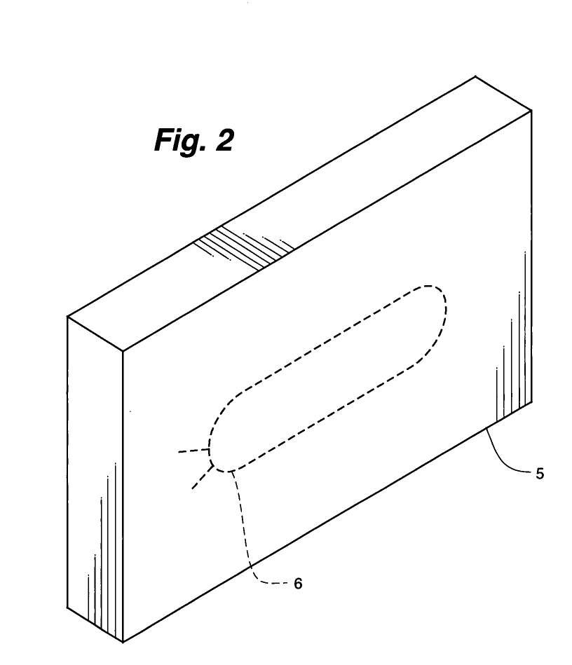

The cardboard containers or packages are made from flat card stock 1, depicted in FIG. 1, that is sized and shaped for later folding into the desired container shape 5 as depicted in FIG. 2. The depicted container 5 includes a perforated region 6 that can be removed to define an opening through which the articles therein can be selectively dispensed.

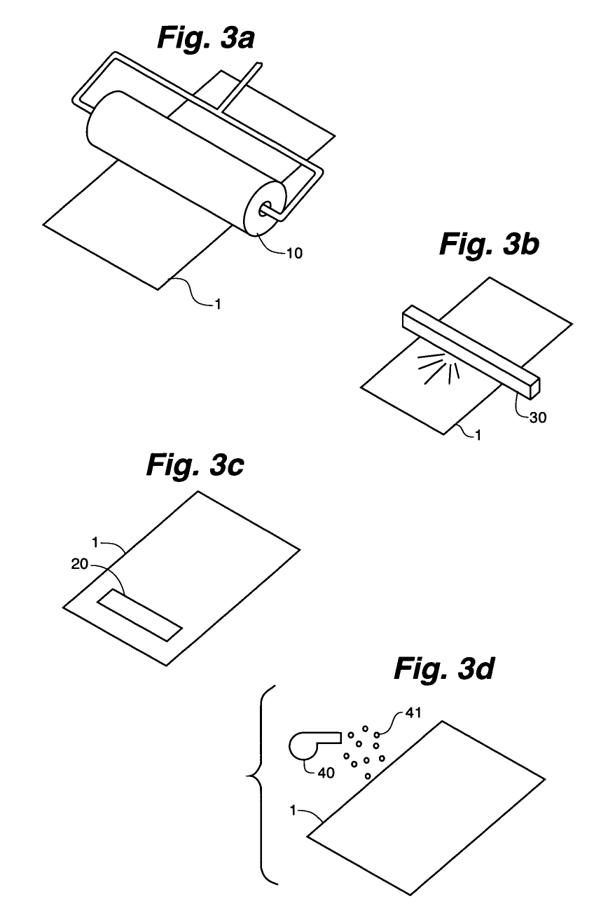

FIGS. 3a-d illustrate exemplary methods of applying scent to the card stock 1 before it is folded into a box 5. One method of applying scent to the container during formation of the container is to roll scent onto part or all of the flat container stock before it is folded, as depicted schematically in FIG. 3a. Such a method employs a wetted roller 10, similar to a power roller painting device or postage stamp wetting device, that has been wetted with a liquid scented composition. Another method, depicted in FIG. 3c, is to adhere a strip 20 of previously scented material to the card stock anywhere on what will be the interior surface. Still another method is to spray the surface from a sprayer 30, as depicted schematically in FIG. 3b. Yet another method is depicted in FIG. 3d in which a fogging machine 40 converts a liquid to a fog 41 that deposits scent onto the card stock. One such fog machine is like a gun that, at the speed of sound, shoots a liquid, causing it to break into a fine mist or fog or aerosol. Other fogging machines convert a liquid to an aerosol, fine mist or fog by heating the liquid. The entire card stock can be passed through the fog or the fog machine may be pointed at the interior surface of the card stock. With any method of applying the scent to the package, the scent would be applied to a portion or all of the surface of the card stock that will be an insides surface when the container is folded into box shape as depicted in FIG. 2.

Any of these scenting methods can be incorporated into an automated assembly line for mass production.

The amount or quantity of scent to be applied is dependent on the desired intensity of scent and the type of scent solution being used, as desired for a given article and application type. Scent application can be varied by reducing or increasing the amount of surface area that scent is applied to.

Scent can be carried in a natural or synthetic oil or in any other liquid infused with scent. Further, vaporized liquids infused with scents can be employed.

After articles are packed into a scented package, the box is sealed shut. Preferably a package size and article quantity is selected in coordination such that there is adequate space between articles and the packaging to allow the scent to permeate throughout the inside of the dispenser and to allow the articles to move around during shipment or transit to further promote the scent vapor transfer or contact application. Transit or shipment for many articles takes many days or a few weeks by sea, rail, and/or truck, which allows enough time to allow scent to “sink in” or transfer. Depending on scent, application or article, packaged articles can be inverted upon unload to further force product to shift inside packaging prior to final storage or shipment to destination.

While this configuration and process for scenting articles is described in conjunction with the scenting of elastomeric gloves, it may be employed to scent any article in a package. For example, tissues may be scented in this manner.

I claim:

1. A method of scenting articles, comprising the steps of:
a) applying scent to the inside of a package; and
b) placing articles to be scented within said package.

2. A method of scenting articles according to claim 1, further comprising the step of:
c) sealing said package with said articles therein.

3. A method according to claim 1, wherein said articles are elastomeric gloves.

4. A method according to claim 1, wherein said scent is applied by rolling a roller wetted by a liquid scent composition onto an interior surface of said package.

5. A method according to claim 1, wherein said scent is applied by adhering a scented strip to an interior surface of said package.

6. A method according to claim 1, wherein said scent is applied by spraying a liquid scented composition onto the interior surface of said package.

7. A method of scenting a box, comprising the steps of:
a) providing card stock sized and shaped for folding into a box;
b) applying scent to the card stock;
c) folding said card stock into a box shape, with the scented side to the inside of the box.

8. A method of scenting articles, comprising the steps of:
a) providing card stock sized and shaped for folding into a box;
b) applying scent to the card stock;
c) folding said card stock into a box shape, with the scented side to the inside of the box;
d) placing articles inside box.

9. A method of scenting articles according to claim 8, wherein said articles are elastomeric gloves.

10. A method of scenting articles according to claim 9, wherein said box includes a perforated section for removal from the box to define an opening therein for dispensing gloves therefrom.

11. A method according to claim 7, wherein said articles are elastomeric gloves.

12. A method according to claim 7, wherein said scent is applied by rolling a roller wetted by a liquid scent composition onto an interior surface of said package.

13. A method according to claim 7, wherein said scent is applied by adhering a scented strip to an interior surface of said package.

14. A method according to claim 1, wherein said scent is applied by converting a liquid scented composition into a fog and passing the package through the fog.

15. A method according to claim 7, wherein said scent is applied by converting a liquid scented composition into a fog and passing the package through the fog.
